(19) United States
(12) Patent Application Publication
(10) Pub. No.: US 2009/0011099 A1
(43) Pub. Date: Jan. 8, 2009

(54) METHOD FOR PRODUCING EXTRUDED NOODLES

(75) Inventors: Jai Hoon Kim, Gyeonggi-do (KR); Soo Hyun Park, Gyeonggi-do (KR); Sung Ug Jung, Seoul (KR); Hyeon Jung Kim, Gyeonggi-do (KR); Nam Jae Kang, Gyeonggi-do (KR); Choon Sang Park, Gyeonggi-do (KR); Seok June Son, Gyeonggi-do (KR); Kyung Bae Kim, Gyeonggi-do (KR); Kyung Hyun Noh, Seoul (KR); Jun Ho Hwang, Seoul (KR); Bong Jik Shin, Seoul (KR)

Correspondence Address: LADAS & PARRY, 5670 WILSHIRE BOULEVARD, SUITE 2100, LOS ANGELES, CA, 90036-5679, US

(73) Assignee: NONG SHIM CO., LTD, Seoul (KR)

(21) Appl. No.: 11/846,361

(22) Filed: Aug. 28, 2007

(30) Foreign Application Priority Data
Aug. 31, 2006 (KR) 2006-83565
May 17, 2007 (KR) 2007-48068
Jul. 11, 2007 (KR) 2007-69732

(51) Int. Cl. A23L 1/16; A23P 1/12

(52) U.S. Cl. 426/451

(57) ABSTRACT

Disclosed is a method for producing extruded noodles including mixing noodle materials; kneading the mixed noodle materials and mixing water into dough and gelatinizing the dough through a first extruder; cooling the gelatinized dough to a temperature of 40° C. or less; extruding strips of noodles from the gelatinized dough through a second extruder; cutting the extruded strips of noodles; putting a designated amount of the cut strips of noodles into a mold so as to mold the noodles; firstly drying the molded noodles at a temperature of 40˜70° C. under a relative humidity of 20% or more for 1˜20 minutes; and secondarily drying the firstly dried noodles at a temperature of 60˜100° C. for 30˜60 minutes. The dough is gelatinized through the first extruder without using a separate mixer, and then continuously passes through the second extruder without applying heat, thereby having an increased uniformity and allowing the extruded strips of noodles to be easily separated from each other. Further, since the drying of the noodles is divided into two steps, the extruded noodle producing method increases the disentangling property of final products of the extruded noodles in cooking, reduces the ingredient elution amount of the noodles, and prevents the generation of cracks of the noodles, thereby providing noodles, which have stability and convenience in circulation, storage, and cooking so as to be easily handled, and have excellent appearance and texture after cooking.

### CROSS-REFERENCE TO RELATED APPLICATION

This application claims the benefit of Korean Patent Application No. 2006-0083565, filed Aug. 31, 2006, and Korean Patent Application Nos. 2007-0048068 and 2007-0069732, in the Korean Intellectual Property Office, the disclosure of which is incorporated herein by reference.

### BACKGROUND OF THE INVENTION

1. Field of the Invention

The present invention relates to a method for producing extruded noodles, and more particularly, to a method for producing extruded noodles, including mixing noodle materials, kneading the mixed noodle materials and mixing water into dough and gelatinizing the dough through a first extruder, cooling the gelatinized dough to a temperature of 40° C. or less, extruding strips of noodles from the gelatinized dough through a second extruder, cutting the extruded strips of noodles, molding the cut strips of noodles; firstly drying the molded noodles at a temperature of 40˜70° C. under a relative humidity of 20% or more for 1˜20 minutes, and secondarily drying the firstly dried noodles at a temperature of 60˜100° C. for 30˜60 minutes.

2. Description of the Related Art

Generally, among traditional noodles, which have been widely used habitually since early times, plain noodles are mainly made from wheat flour, cold noodles are mainly made of wheat flour, starch, and buckwheat flour, and Chinese noodles are mainly made of starch.

In a conventional method for producing noodles using an extruder, materials of prescription according to kinds of noodles are mixed and kneaded into dough with a high added water amount of 55% or more, and the dough is gelatinized and extruded via a single extruder. The noodles extruded by the extruder are cooled by cold water or cold air blown by a blower, and are hung on noodle bars. Then, the noodles hung on the noodle bars pass through ripening by refrigeration, freezing, and defrosting steps, are rubbed by hand so as to be separated from one another, and are sun-dried or mechanically-dried. Thereafter, the noodles are cut to a regular length and are packed into finished products, and the products are circulated.

As described above, the conventional method for producing extruding noodles, including cold noodles and Chinese noodles, is achieved by a labor-intensive process, which mostly depends on manpower from the mixture of raw materials to the package of the noodles into finished products. Accordingly, in case that the process is normally carried out, it takes at least 40 hours to produce the finished products, which can be circulated, starting from the mixture of the materials and the production of mixing water. Thus, the conventional method is disadvantageous in that the productivity is excessively low.

Further, the conventional method requires a separate space for freezing the noodles and a wide working space for drying equipment, such as a dryer.

In case of extruded noodles, which are dried by a conventional drying method, many middle portions of the noodles are cracked, and thus the noodles are cut off during cutting prior to packing, circulating, or cooking. Further, the texture of the dried noodles is dense, and thus when the noodles are cooked in water, the speed of moisture penetration into the noodles is low and the cooking time is long. Moreover, since the noodles are stuck to each other from the production process, the noodles need to be separated from each other by hand prior to cooking, or be separated from each other with chopsticks during boiling.

Instant extruded noodles, such as cold noodles and Chinese noodles, which are produced by the above-described traditional method, are discontinuously produced through a complicated process, thus having a high production loss and causing a difficulty in quality control.

2,000 years ago, the above-described dried cold noodles had been mainly produced. Recently, boiled cold noodles have been widely circulated. Such boiled cold noodles are submerged in alcohol and packed into unit products, and the obtained unit products are circulated in a refrigeration state. These boiled cold noodles are produced by the conventional cold noodle producing method (including ripening by refrigeration, freezing, and defrosting steps) and circulated in the refrigeration state, thus causing additional burdens of circulation and distribution costs compared with cold noodles circulated in the normal temperature state.

Further, since the cold noodles submerged in alcohol and circulated in the refrigeration state have a moisture content of around 35%, it is known that the chewy texture, which is a characteristic of extruded noodles, is lowered due to retrogradation of starch during circulation. Further, peculiar smell of alcohol remains after cooking and thus provides dissatisfaction to customers.

There are several conventional methods for continuously producing cold noodles. First, in Korean Patent Application No. 10-2000-0039891 entitled “Improved extruded noodles and manufacturing process thereof”, noodles are obtained by a twin extruder, and are waved so as not to be stuck to each other. In this case, the waves of the noodles were maintained after cooking and thus there was a limit to form the peculiar appearance of the cold noodles. Further, in Korean Patent Application No. 10-2000-0039890 entitled “Improved process for preparing instant extruded noodles”, forming of a noodle base, cutting of the base into noodles, and steam boiling of the noodles are carried out using a process for producing instant fried noodles, called ‘ramyon’, in order to provide the peculiar texture of the cold noodles, and waves of the noodles are straightened by spraying cold water and the noodles are put into a wax mold so as to be molded. These noodles is disadvantageous in that the peculiar texture of the noodles are relatively low compared with directly extruded noodles and the dryability of the noodles is lowered due to cold water sprayed to release waves of the noodles.

Particularly, in case that noodles are dried by the above method, the noodles are severely cracked after 2˜3 months have elapsed, and thus the quality of noodle products is remarkably lowered. Further, the noodles are easily cut during cooking.

### SUMMARY OF THE INVENTION

Therefore, one aspect of the invention is to provide a method for producing extruded noodles, which allows the noodles to have uniformly improved quality, prevents the noodles from being stuck to each other, reduces the generation of cracks of the noodles, improve the disentangling property of the noodles in cooking and the restoring power of the noodles, omits a refrigerating or freezing step, and does not require a separate device or a working space for a drying step, thus reducing a production time and cutting down the cost of production of the noodles.

Another aspect of the invention is to provide a method for producing extruded noodles, which allows the noodles to have a rectilinear shape, differing from conventional noodles having a waved shape so as to be easily separated from each other, thus satisfying customer's esthetic taste.

In accordance with one aspect, the present invention provides a method for producing extruded noodles comprising mixing noodle materials; kneading the mixed noodle materials and mixing water into dough and gelatinizing the dough through a first extruder; cooling the gelatinized dough to a temperature of 40° C. or less; extruding strips of noodles from the gelatinized dough through a second extruder; cutting the extruded strips of noodles; putting a designated amount of the cut strips of noodles into a mold so as to mold the noodles; firstly drying the molded noodles at a temperature of 40˜70° C. under a relative humidity of 20% or more for 1˜20 minutes; and secondarily drying the firstly dried noodles at a temperature of 60˜100° C. for 30˜60 minutes.

In order to produce extruded noodles, a single extruder having both of a gelatinizing function and an extruding function is generally used. In the present invention, an extruder (first extruder) only having a gelatinizing function and an extruder (second extruder) only having an extruding function are separately used such that gelatinized dough is cooled to a temperature of 40° C. or less before putting into the second extruder, and heat is not applied to the second extruder.

Conventional extruded noodles have a high added water amount of 55% or more, and are completely gelatinized through one extruder. On the other hand, extruded noodles produced by the method of the present invention are gelatinized through the first extruder prior to extrusion so as to maintain a degree of gelatinization of 70˜95%, thus preventing extruded strips of noodles from being stuck to each other.

This dough is fed to the second extruder. Then, while cooling water is circulated into a cylinder and the cylinder is vacuumized simultaneously, strips of noodles are extruded through a die.

Thereafter, the extruded strips of noodles are cut, and are molded according to the shape of wax mold, and then the molded strips of noodles are dried by hot air, thus producing extruded noodles. During drying, designated temperature and humidity are maintained and hot air is blown and circulated.

Extruded noodles, dried by a general hot air drying method, are disadvantages, such as the elongation of a cooking time, compared with boiled noodles, and the generation of cracks during circulation, as described above. Accordingly, methods for solving these disadvantages during drying are required.

### BRIEF DESCRIPTION OF THE DRAWINGS

These and/or other aspects and advantages of the invention will become apparent and more readily appreciated from the following description of the embodiments, taken in conjunction with the accompanying drawings in which:

FIG. 1 is a schematic view illustrating a method for producing extruded noodles in accordance with the present invention.

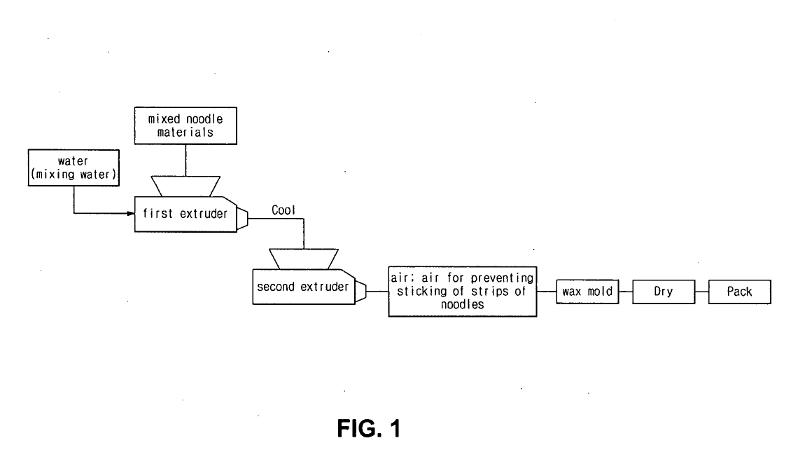

### DETAILED DESCRIPTION OF THE PREFERRED EMBODIMENTS

Reference will now be made in detail to the embodiments of the present invention, an example of which is illustrated in the accompanying drawings, wherein like reference numerals refer to like elements throughout. The embodiments are described below to explain the present invention by referring to the annexed drawings.

Hereinafter, the present invention will be described in more detail through a preferred embodiment.

### Preferred Embodiment

Mixing of Noodle Materials

10˜90% by weight of wheat flour, and 10˜90% by weight of one or at least two selected from the group consisting of starch, such as potato starch, sweet potato starch, tapioca starch, and corn starch, buckwheat flour, wild rice flour, and acorn flour are put into a first extruder.

Kneading and Gelatinizing

Using the first extruder, the noodle mixture is kneaded into dough and the dough is gelatinized by heat, simultaneously.

Particularly, in accordance with a method for producing extruded noodles of the present invention, the amount of mixing water, which is mixed with the noodle mixture, is 10˜50% of the weight of the noodle mixture. Compared with general extruded noodles (cold noodles) having an added water amount of 55˜75%, a comparatively small amount of water is mixed with the noodle mixture in the present invention. When the amount of the mixing water is more than 50%, strips of noodles are stuck to each other when the noodles are extruded, and when the amount of the mixing water is less than 10%, the formation of strips of noodles is impossible.

Cooling Dough

The dough gelatinized by the first extruder is cooled to 40° C. or less. When the gelatinized dough is cooled, approximately 5% or more of the water content in the cooled dough is reduced. Thus, the dough can be easily dried in a subsequent drying step. Further, it is important that the dough, passed through the first extruder, is cooled and put into a second extruder simultaneously at regular time intervals.

Extruding Strips of Noodles Through Extruder

When strips of noodles are extruded through the second extruder, it is important that the noodles are extruded through a die of the extruder under the condition that heat is not applied to the dough, differing from the conventional extruded noodle producing method, in which heat of a temperature of around 100° C. is applied to gelatinize starch of the dough. In case that the strips of noodles are extruded under the condition that heat is applied to the dough to gelatinize starch of the dough, the sticking of the strips of noodles to each other occurs and exerts a poor influence on a subsequent step. When cold air is blown to an extruder outlet as soon as the strips of noodles are extruded through the die of the second extruder, the strips of noodles are slightly dried, and thus are not stuck to each other.

Cutting and Molding Strips of Noodles

The extruded strips of noodles are cut to a length of 20˜60 cm, and are put into a designated mold.

Drying Strips of Noodles

The drying of the strips of noodles is divided into two steps.

The strips of noodles are firstly dried at a low temperature of 40˜70° C. under a relative humidity of 20% or more for 1˜20 minutes. Thereafter, the strips of noodles are secondarily dried at a temperature of 60˜100° C. for 30˜60 minutes so as to have a water content of 9˜12% after drying.

The reason why the drying is divided into the two steps, i.e., a low temperature drying step under the condition that the relative humidity is controlled and a high temperature drying step, is that the drying speed is controlled. In case that the drying speed is excessively high, the surfaces of the noodles, contacting air, are first dried and hardened and thus the drying of the insides of the noodles is delayed so that the shapes of the noodles are bent, and the noodles are twisted due to internal stress so that the noodles get broken during drying and are split after drying.

When the surfaces of the strips of noodles are dried, there is a difference of water contents between the insides and surfaces of the noodles, and water is transferred from the insides of the noodles to the surfaces of the noodles. When the transfer speed of water from the insides of the noodles to the surfaces of the noodles is lower than the drying speed of the surfaces of the noodles, the above matter happens. Accordingly, it is important that the evaporation of water from the surfaces of the noodles is reduced so as to induce the diffusion of water from the insides of the noodles to the surfaces of the noodles.

Thus, when the noodles are firstly dried under the condition that moisture is applied to the noodles at a low temperature, water is first transferred from the insides of the noodles to the surfaces of the noodles, as described above.

Further, compared with the conventional extruded noodles obtained by a general hot air drying method, the extruded noodles of the present invention have a surface texture, which is not dense, and thus rapidly absorb water in cooking and have an increased restoring power. The noodles may be dried only at a low temperature for a long time. However, in the case, it takes long time to dry the noodles and an excessively long space for the layout of a plant is required, thus lowering economic efficiency and causing an obstacle to industrialization.

Hereinafter, extruded noodles produced by the method of the present invention will be described in comparison with comparative examples, in which conditions of the method are varied.

### EXAMPLE

60% by weight of wheat flour and 40% by weight of potato starch and buckwheat flour were put into a first extruder. Here, the amount of mixing water added to the noodle mixture was 30% by weight to the noodle mixture. 1% by weight of refined salt was dissolved in the mixing water in advance.

While the noodle mixture and the mixing water were simultaneously put into the first extruder, the temperature of a barrel was controlled so that the mixture can be kneaded into dough and the dough can be gelatinized simultaneously. The gelatinized dough was cooled to a temperature of 30° C., and then a regular amount of the gelatinized dough was put into a second extruder at a time and was extruded into strips of noodles. Here, die holes of the extruder had a diameter of 0.7 mm.

The strips of noodles extruded through the second extruder were cut into a length of 40 cm, and a designated amount of the cut strips of noodles was put into a wax mold. Then, the noodles in the wax mold were transferred to a dryer. Thereafter, the noodles were firstly dried at a temperature of 50° C. under a relative humidity of 45% for 9 minutes, and then were secondarily dried at a temperature of 70° C. for 1 hour.

Table 1 below shows test results according to drying conditions.

TABLE 1

| | First drying | | Second drying | |
|---|---|---|---|---|
| Drying conditions | Less than 40° C. | More than 70° C. | Less than 60° C. | More than 100° C. |
| Appearance (generation | — | Generation of | — | Generation of some |
| of cracks) | | many cracks | | cracks |
| Drying time | More than 1 hour | | More than 2 hours | |
| Cooking time | More than 4 | — | More than 4 minutes | — |
| | minutes | | | |
| Texture property | Hard texture | Strips of noodles | — | Some strips of |
| | | were cut during | | noodles were cut |
| | | cooking | | during cooking |

As shown Table 1 above, when the noodles are firstly dried at a temperature of 70° C. or more, many cracks of the strips of noodles were generated and many strips of noodles were cut during cooking, and when the noodles are firstly dried at a temperature of 40° C. or less, the drying time and the cooking time of the noodles were elongated and the texture of the noodles was hard after cooking.

Further, when the noodles are secondarily dried at a temperature of 100° C. or more, cracks of the strips of noodles were generated and the strips of noodles were cut during cooking, and when the noodles are secondarily dried at a temperature of 60° C. or less, the drying time of the noodles was more than 2 hours and the cooking time of the noodles was more than 4 minutes.

### Comparative Example 1

### Conventional Process for Producing Extruded Noodles (Boiled Noodles)

A noodle mixture including noodle materials, prepared at the same ratio as that of the above Example, and mixing water were kneaded into dough.

Here, the amount of the mixing water added to the noodle mixture was 60% by weight to the noodle mixture.

The obtained dough was put into an extruder, and thus was extruded into strips of noodles. Here, die holes of the extruder had a diameter of 0.8 mm. The strips of noodles were extruded at a high temperature of 100° C., and the extruded strips of noodles were cooled and slightly dried through a cooling fan. The strips of noodles, passed through a conveyer, were cut to a length of 40 cm, and the cut strips of noodles were put into a refrigerator at a temperature of 10° C. for 12 hours so as to ripen by refrigeration. Thereafter, the strips of noodles were put into a freezer at a temperature of −15° C. or less for approximately 24 hours. After freezing, the strips of noodles were defrosted at the normal temperature and separated from each other. Then, the noodles were submerged in alcohol for approximately 5 minutes so as to be sterilized, and were packed. Thereby, finished products of cold noodles were obtained.

### Comparative Example 2

### Conventional Process for Producing Extruded Noodles (Dried Extruded Noodles)

After strips of noodles were extruded and the extruded strips of noodles passed through various steps up to a defrosting step by the same method as that of Comparative example 1, the noodles were dried in a dryer for approximately 6 hours. Thereby, finished products of dried cold noodles were obtained.

### Comparative Example 3

### Korean Patent Application No. 10-2000-0039891

After a noodle mixture including noodle materials, prepared at the same ratio as that of the above Example, and mixing water were kneaded into dough, the noodles were waved through a transfer conveyer having a speed lower than that of the extrusion speed and cold water was sprayed onto the noodles. Then, the noodles were dried by the same method as that of the above Example. Thereby, finished products of cold noodles were obtained.

### Comparative Example 4

### Korean Patent Application No. 10-2000-0039890

After a noodle mixture including noodle materials, prepared at the same ratio as that of the above Example, and mixing water were kneaded into dough, an extruded noodle base passed through rolling, cutting, and wave forming steps of a general ramyon producing process, and then passed through a steam boiling step. Thereafter, the noodles were straightened by cold water sprayed thereonto, and the straightened noodles were put into a wax mold. Then, the noodles were dried by the same method as that of the above Example. Thereby, finished products of the cold noodles were obtained.

### Comparative Example 5

### General Drying Method

Finished products of extruded noodles were produced by the same method as the above Example. However, the noodles were dried at a temperature of 80□ for 45 minutes.

### Comparative Example 6

### High-Temperature Drying Method

Finished products of extruded noodles were produced by the same method as the above Example. However, the noodles were dried at a temperature of 120° C. for 7 minutes.

### Comparative Example 7

During kneading a noodle mixture including noodle materials and mixing water into dough, the amount of the mixing water added to the noodle mixture was 51% by weight of the noodle mixture. Other steps were the same as those of the above Example. Thereby, finished products of extruded noodles were obtained.

### Comparative Example 8

Dough gelatinized through a first extruder was put into a second extruder under the condition that the dough is maintained at a temperature of 45° C. Other steps were the same as those of the above Example. Thereby, finished products of extruded noodles were obtained.

### Comparative Example 9

Extruded noodles were firstly dried at a temperature of 50° C. under a relative humidity of 15% for 9 minutes. Other steps were the same as those of the above Example. Thereby, finished products of the extruded noodles were obtained.

### Test Example

### Sensory Test

A sensory test was performed on the extruded noodles produced by the above Example and the Comparative examples 1 to 7 in respect of texture and general preference. Since chewy texture is an important factor of cold noodles, a chewy property and general preference were evaluated. Fifteen persons, which are sufficiently trained, sampled the extruded noodles, and then classified the extruded noodles into five grades, for example, good (5 points), slightly good (4 points), normal (3 points), slightly poor (2 points), and poor (1 point). Then, the extruded noodles were evaluated by the mean values of the obtained points given by the persons. Table 2 below shows test results. Appearance is a criterion for determining whether or not the noodles are cracked due to the diffusion of water during drying and are waved. A disentangling property is a criterion for determining the sticking degree of strips of noodles, and was classified into five grades from good to poor after the noodles were cooked for cooking times according to the respective noodles.

Further, results of cutting of the noodles in cooking after long-time storage (more than 3 months) are shown in Table 2 below. It is important that the instant extruded noodles maintain their quality for at least 3 months. The cutting of the noodles in cooking was evaluated by the same method as that of the sensory test.

TABLE 2

| | | | | | Cutting of strips |
|---|---|---|---|---|---|
| | | | Disentangling | | of noodles in |
| | | | property (sticking | | cooking after |
| | | | degree of strips | general | long-time |
| Item | Chewy property | appearance | of noodles) | preference | storage |
| Example | Good | Good | Good | Good | Good |
| Comparative | Normal | Good | Good | Slightly good | Good |
| example 1 | | | | | |
| Comparative | Good | Good | Good | Good | Good |
| example 2 | | | | | |
| Comparative | Slightly good | Poor | Slightly good | Normal | Good |
| example 3 | | | | | |
| Comparative | Slightly good | Poor | Slightly good | Normal | Good |
| example 4 | | | | | |
| Comparative | Good | Normal | Good | Slightly good | Normal |
| example 5 | | | | | |
| Comparative | Slightly good | Poor | Good | Normal | Poor |
| example 6 | | | | | |
| Comparative | Good | Slightly good | Poor | Normal | Good |
| example 7 | | | | | |
| Comparative | Good | Normal | Normal | Normal | Good |
| example 8 | | | | | |
| Comparative | Good | Normal | Good | Slightly good | Slightly poor |
| example 9 | | | | | |

In terms of chewy property, most of the extruded noodles were rated slightly good or good. This property is caused by the drying of noodles formed by extrusion. Since the noodles produced by the Comparative example 1, which are boiled noodles, had higher water content than that of the dried extruded noodles, it is known that the chewy property of the above boiled noodles was lowered due to the retrogradation of starch during storing.

In terms of appearance, the extruded noodles produced by the Comparative examples 3 and 4 were waved, and thus were rated poor. The extruded noodles produced by the Comparative example 6, which were dried under a high temperature of 120° C., had the bright tone of color, but had many cracks at several places of strips of noodles. Further, the extruded noodles produced by the Comparative example 9, had a lesser extent of cracks than that of the extruded noodles produced by the Comparative example 6, but still had cracks at several places of strips of noodles and were cut when the noodles were stored for a long time.

In the sensory test of noodles, a mass of strips of noodles, in which the strips of noodles are stuck to each other, exerts a poor influence on quality estimation. As a result of the estimation, the extruded noodles produced by the Comparative examples 7 and 8 had many masses, in which strips of noodles are stuck to each other, after cooking, and thus were rated poor, and the extruded noodles produced by the Comparative examples 3 and 4 had a few masses, in which strips of noodles are stuck to each other, due to water remaining on the surfaces of the noodles before drying when water is sprayed so as to straighten waves of the noodles, as shown in Table 2 above.

In terms of quality, it is known that the extruded noodles produced by the method of the present invention were generally preferred, compared with the extruded noodles produced by the conventional methods.

Further, Table 3 below shows entire noodle production time and cooking time according to the above Example and the Comparative examples 1 to 9.

TABLE 3

| | Production time (from | | |
|---|---|---|---|
| Item | kneading to drying) | Cooking time | |
| Example | Less than 1 hour | 2~3 | minutes |
| Comparative example 1 | More than 36 hours | 1 | minute |
| Comparative example 2 | More than 42 hours | 2~3 | minutes |
| Comparative example 3 | Less than 2.5 hours | 3~4 | minutes |
| Comparative example 4 | Less than 2.5 hours | 3~4 | minutes |
| Comparative example 5 | Less than 1.5 hours | 3~4 | minutes |
| Comparative example 6 | Less than 30 minutes | 2~3 | minutes |
| Comparative example 7 | Less than 1 hour | 3~4 | minutes |
| Comparative example 8 | Less than 1 hour | 3~4 | minutes |
| Comparative example 9 | Less than 1 hour | 2~3 | minutes |

As shown in Table 3 above, the extruded noodle producing method of the Example above of the present invention had a remarkably reduced production time, compared with the extruded noodle producing methods of the Comparative examples 1 and 2, thus allowing extruded noodles to be mass-produced and simplifying a production process. Further, the extruded noodle producing method of the Example above of the present invention and the extruded noodle producing methods of the Comparative examples 5 and 6, in which strips of noodles are extruded from dough, gelatinized in advance, through an extruder and are dried, had a comparatively short production time.

The extruded noodles produced by the Comparative example 1, which have a relatively high water content, had the shortest cooking time of 1 minute, and the extruded noodles dried by conventional drying methods had a relatively long cooking time of 2˜4 minutes. The extruded noodles produced by the above Example and the Comparative example 6, which were dried under a high temperature, i.e., 120° C., had a surface texture, which is not dense relatively, due to the high-temperature drying method, and thus rapidly absorbed water in cooking, thereby reducing the cooking time by approximately 1 minute.

Further, the extruded noodles produced by the Comparative examples 7 and 8 were stuck to each other in cooking so as not to easily disentangle, and thus formed masses of strips of noodles. In order to solve this problem, the cooking time of these extruded noodles was increased to more than 1 minute, compared with the extruded noodles produced by the Example of the present invention, and then the ingredient elution amount of the these noodles was rapidly increased due to the increase of the cooking time.

As apparent from the above description, the extruded noodle producing method of the present invention, in which the drying of the noodles is divided into a first drying step carried out under a low-temperature and humidification state and a second drying step carried out under a high-temperature state, omits a freezing or refrigerating step, necessarily required by a conventional noodle producing method, and does not require a separate device and a working space for drying equipment, such as a dryer, thus reducing a production time and cutting down the cost of production for equipment and labor.

The extruded noodle producing method of the present invention produces extruded noodles, the surface textures of which are not dense but are sparse, so that water is easily permeated into the surfaces of the noodles and transferred in the noodles so as to reduce the drying time. Further, the extruded noodles are easily disentangled in cooking, rapidly absorb water, and have an increased restoring power, thus being simply cooked.

The extruded noodle producing method of the present invention, in which the drying time is shortened, reduces cracks of the noodles so as to prevent the noodles from cutting during circulation and cooking, and allows the noodles to maintain a straight shape rather than a waved shape, thus providing noodles, which are simply cooked and preferred by customers.

The extruded noodle producing method of the present invention separates a gelatinizing step and an extruding step from each other such the gelatinizing step is performed prior to the extruding step, and sufficiently cools gelatinized dough so as to reduce the water content in the dough, thereby preventing strips of noodles from being stuck to each other and thus providing noodles having improved texture and appearance.

That is, the extruded noodles produced by the extruded noodle producing method of the present invention reproduce the peculiar texture and appearance, compared with conventional extruded noodles, are dried, and are simply cooked, thus being circulated at the normal temperature. Further, the extruded noodles have remarkably reduced cracks, thus being stably and conveniently stored and circulated.

In case of noodles submerged in alcohol, which are widely circulated in the market now, i.e., (cold noodles or noodles called ‘woodong’), an alcohol flavor cannot be sufficiently removed from the noodles during cooking. These noodles in a non-dried state have high water content, and thus may form a mass of strips of noodles or have a lowered texture due to retrogradation of starch during a long-time storage or circulation in a refrigeration state. However, cold noodles produced by the present invention are in a dried state and thus don't have to be stored in a cold state, and have a short cooking time compared with conventional dried cold noodles. Further, the cold noodles produced by the present invention have a texture similar to that of traditional cold noodles, and reduces the deterioration of the texture due to the retrogradation of starch during circulation, thus having a chewy texture.

Although embodiments of the invention have been shown and described, it would be appreciated by those skilled in the art that changes may be made in these embodiments without departing from the principles and spirit of the invention, the scope of which is defined in the claims and their equivalents.

1. A method for producing extruded noodles comprising:
mixing noodle materials;
kneading the mixed noodle materials and mixing water into dough and gelatinizing the dough through a first extruder;
cooling the gelatinized dough to a temperature of 40° C. or less;
extruding strips of noodles from the gelatinized dough through a second extruder;
cutting the extruded strips of noodles;
putting a designated amount of the cut strips of noodles into a mold so as to mold the noodles;
firstly drying the molded noodles at a temperature of 40˜70° C. under a relative humidity of 20% or more for 1˜20 minutes; and
secondarily drying the firstly dried noodles at a temperature of 60˜100° C. for 30˜60 minutes.

2. The method according to claim 1, wherein the noodle materials include 10˜90% by weight of wheat flour, and 10˜90% by weight of at least one selected from the group consisting of potato starch, sweet potato starch, tapioca starch, corn starch, buckwheat flour, wild rice flour, and acorn flour.

3. The method according to claim 1, wherein the amount of the mixing water is 10˜50% of the weight of the noodle materials.

4. The method according to claim 1, wherein the dough after the gelatinization has a gelatinization degree of 70˜95%.

5. The method according to claim 1, wherein die holes of the first and second extruders have a diameter of 0.4˜1.5 mm.

6. The method according to claim 1, wherein the gelatinization of the dough through the first extruder is achieved by heat supplied from a barrel and heat supplied due to the shearing of the noodle materials with a screw.

7. The method according to claim 1, wherein the noodles are one selected from the group consisting of cold noodles, Chinese noodles, and chewy noodles.
